(19) United States
(12) Patent Application Publication
(10) Pub. No.: US 2011/0229862 A1
(43) Pub. Date: Sep. 22, 2011

(54) Method and Apparatus for Training Brain Development Disorders

(75) Inventor: Nishith Parikh, Raritan, NJ (US)

(73) Assignee: OHM TECHNOLOGIES LLC, Raritan, NJ (US)

(21) Appl. No.: 13/031,928

(22) Filed: Feb. 22, 2011

Related U.S. Application Data
(60) Provisional application No. 61/340,510, filed on Mar. 18, 2010.

(51) Int. Cl. G09B 19/00

(52) U.S. Cl. 434/156

(57) ABSTRACT

The present invention relates to the field of education of human subjects, and more specifically to a computer program for training the brain development disorder where in human subjects are impaired of social interaction and communication. The program deliver animated content to the subject and varies the size, clarity, colors, background images, animated characters, sound with animation, method of instructions, so they would be more easily distinguished by the subject and thereby gradually improves the subject's neurological processing and memory of the elements through repetitive stimulation. Thus the system, method and apparatus of the present invention maximizes the effectiveness and efficiency of learning by adding a reward delivery system to deliver the object of the student's interest upon achieving the goal set by the trainer. The system includes modules configuration system, user validation system, content delivery system, user response/input system, monitoring system and feedback system. The configuration engine includes a progress module which monitors a user's performance on any of learn, review and test modules and changes the future lessons based on the monitored performance. The content delivery system includes help or instructions screen to provide assistance with any of the learning lessons.

### RELATED APPLICATION

This application claims priority under 35 U.S.C. 119(e) from U.S. Provisional Application No. 61/340,510 filed Mar. 18, 2010 for “Method and Apparatus for Training Brain Development Disorders”, the entire disclosure of which is hereby incorporated by reference.

### FIELD OF INVENTION

The present invention relates to the field of education of human subjects, and more specifically to a computer program for training the brain development disorder where in human subjects are impaired of social interaction and communication. The program deliver animated content to the subject and varies the size, clarity, colors, background images, animated characters, sound with animation, method of instructions, so they would be more easily distinguished by the subject and thereby gradually improves the subject's neurological processing and memory of the elements through repetitive stimulation. Thus the system, method and apparatus of the present invention maximizes the effectiveness and efficiency of learning by adding a reward delivery system to deliver the object of the student's interest upon achieving the goal set by the trainer.

### DESCRIPTION OF THE RELATED ART

Autism is a disorder of neural development characterized by impaired social interaction and communication, and by restricted and repetitive behavior. These signs all begin before a child is three years old. Autism affects information processing in the brain by altering how nerve cells and their synapses connect and organize; how this occurs is not well understood. The two other autism spectrum disorders (ASD) are asperger syndrome, which lacks delays in cognitive development and language, and PDD-NOS, diagnosed when full criteria for the other two disorders are not met.

As per Centers for Disease Control and Prevention, 4 million children are born in the United States every year. Approximately 36,500 of these children will eventually be diagnosed with an ASD. Recent studies have estimated that the lifetime cost to care for an individual with an ASD is $3.2 million. Assuming the prevalence rate has been constant over the past two decades, we can estimate that about 730,000 individuals between the ages of 0 to 21 have an ASD. FIG. 1 illustrates the bar chart of the number (per 1,000 U.S. resident children aged 6-17) of children aged 6-17 who were served under the individuals with Disabilities Education Act (IDEA) with a diagnosis of autism, from 1996 through 2007.

More children are diagnosed with autism each year than cancer, aids and diabetes combined. 1 out of every 150 children born today is on the autism spectrum. In New Jersey the rate is an incredible 1 out of every 94 children. Tragically, the needs of children with autism are often not met in a traditional special education environment, and parents are unprepared to deal with the daily challenges of having a child with autism. For years, different modes of technology have been used to improve the quality of life of people who have various developmental disabilities. However, the varied use of technology for children with autism continues to receive limited attention, despite the fact that technology tends to be of interest for some of these children. It is well known that children with autism have defects on their social skills but not in the skills that do not have a social component. The use of new technologies which do not rely on social figures like teachers) may be better able to induce information and facilitate learning. Following are the issues as a major challenges and deficiencies in the education of autistic students:
1. There are none or very few technological tools available which address the issues of therapeutic educational intervention and mass data collection in a centralized place for research purposes
2. Data collection and economic research is impeded because of the manual process of academic assessment and remediation. To enhance the effectiveness of educational intervention for autistic student's state-of-the-art technologies must be utilized for more comprehensive data analysis.
3. Educational intervention is being offered by experts only for a limited time during school hours only and not during after-school and home based programs.
4. Even if the student is getting some training at home, it is not consistent (and frequently detrimental) to the educational programming the student is at school. Research indicates that students with ASD need consistency in their educational programming.
5. Even though many parents are very proactive and knowledgeable, they are frequently not able to effectively supplement a student's educational programming without the utilization of technology to ensure consistency of day and evening curriculum.
6. Most of the after-school educational programming is ineffective because it does not utilize seamless technology to ensure consistent assessment and remediation before, during and after-school.
7. There has been a great deal of research related to the diagnosis and cure of Autism. However, there has been very little substantive research on therapeutic educational programming designed help autistic students master day to day activities and become significantly more self-sufficient.
8. The needs of children with autism are often not met in a traditional special education environment. All too often parents are unprepared to deal with the daily challenges of having a child with autism.

For the student with ASD and their family, the education intervention and research on the therapeutic solution to achieve their highest level of independence within their home, school and community is equally as important as the research on the cause and prevention of autism. The improvement in educational interventions in autistic students will directly help hundreds of thousands of students in the United States and millions globally.

There are few standalone supportive technologies available for autism. Technologies such as videotaping, computers and adaptive hardware, complex voice output devices have the potential to transform the education of autistic students.

Videotaping: Children with autism are often highly interested, motivated and thus attentive to videos. Many children enjoy repetitive viewing of videos due to the “predictability” of the information given; that, knows what's coming up next. Thus videotaping can serve as an excellent tool with which to teach numerous skills to children with autism. Simon Baron-Cohen, one of the world's preeminent autism experts, developed the DVD, and he says his research shows that it brings significant improvements to children with autism, a syndrome that has stubbornly resisted treatment after treatment. Called The Transporters, the DVD aims to teach kids on the higher level of the autistic spectrum a key skill that many of them find nearly impossible: how to understand emotions. There are different kinds of DVDs available in the market that Teaches Kids with Autism to Understand Emotions. The emotions are portrayed with the help of an animated cable car with a live-action human face and the emotions are explained by a narrator. The final product comprises of 15 five-minute episodes along with 30 interactive quizzes and a written guide for parents. Watch Me Learn is video based program teaches social skills.

Computers: Research on the use of computers with students with autism revealed the following: Increase in focused attention, overall attention span, in-seat behavior, Increase in fine motor skills, generalization skills (from computer to related non-computer activities), agitation and decrease in self-stimulatory behaviors and preservative responses. Computers are commonly infused into the child's daily curriculum for reward and/or recreational purposes.

Adaptive Hardware and Software: In order to access the computer, some children with autism are using a standard computer adapted with certain devices for easy access to the computer like Touch Window to “navigate” and “interact”, Intellikeys as an alternative keyboard for easy connection to a computer, Big Keys and Big Keys Plus an alternative alphabet keyboard that has been specifically designed for young children, Trackballs to move the mouse around the screen by rolling a stationary “ball” around with fingertips or hand and some software that focuses on a variety of skill.

Research shows Animation DVD helps children with autism to recognize human emotions. Children with autism tend to avoid looking at human faces and find it hard to understand why facial features move in the way that they do. This inability to read emotions on the human face impairs their ability to communicate with other people. This inability impairs their ability to learn and get training from the teacher where they have to utilize their social skills. Researchers believes a customized training offered and delivered by non humans in a repeated manner using prefer predictable patterns to teach social skills and language will be effective using animated material combined with sound effect and interesting audio commands and/or information. Subject with autism are often fascinated by rotating wheels, spinning tops, rotating fans, and mechanical, lawful motion. Subject with autism love watching films about vehicles because, according to one theory children and adults with autism spectrum conditions are strong ‘systemisers’.

There has thus been a need in the art to develop a method and apparatus that allows a subject is drawn to predictable, rule-based systems, whether these are repeating patterns in the trial/game/lesson and utilize autistics subject's affinity towards lawful repetitions. Whereby it is desirable to provide a method and apparatus which effortlessly delivers training material that does not change and they are the same every time. Moreover the present invention provides a program which disables difficulty in dealing with the social world because it is always changing unpredictably and is different every time for kids with autism, wherein the program would deliver combination of 3D/2D content dynamically based on the student's skill level, area of interest and mental age of the subject and adjust the type of the delivered content material based on the input received from the subject and/or subject's behaviors and body movements.

### OBJECTS OF THE INVENTION

It is therefore a primary object of the invention to provide to a system, apparatus and method for training individuals with disorder of neural development characterized by impaired social interaction and communication, and by restricted and repetitive behavior.

It is another object of the present invention to provide an apparatus which reduces the social interaction and provides the repetitive interactive training anytime anywhere using computer and save all the activities in a centralized database.

It is another object of the present invention to provide an apparatus and method that incorporates a number of different programs to be played by the subject.

It is another object of the present invention to provide computer programs for training the brain development disorder where in human subjects are impaired of social interaction and communication.

It is another object of the present invention, wherein the programs deliver animated content to the subject and varies the size, clarity, colors, background images, animated characters, sound with animation, method of instructions, so they would be more easily distinguished by the subject, and thereby gradually improves the subject's neurological processing and memory of the elements through repetitive stimulation.

It is another object of the present invention, wherein the program delivers combination of 3D/2D content dynamically based on the student's skill level, area of interest and mental age of the subject and adjusts the type of the delivered content material based on the input received from the subject and/or subject's behaviors and body movements.

It is another object of the present invention, wherein the adaptive adjustments encourage the subject to continue with the repetitions, and the number of repetitions should be sufficient to develop the necessary neurological connections for normal temporal processing of concept.

It is another object of the present invention, wherein the program provides encouraging animation in the event of success and delivers entertaining content material in the event of the expiration of the attention span of the subject.

It is another object of the present invention, wherein the attention span is measured based on the subject's profile, past history using camera and motion detector and the timer used in the system.

It is another object of the present invention, wherein the method and apparatus utilizes a touch screen technology and colorful customized animation that attracts the attention of students with autism and significantly enhances the ability of the training material to provide needed educational interventions.

It is another object of the present invention, wherein the method of intervention relies exclusively on the teacher for implementation.

It is another object of the present invention, wherein the method of information delivery is used for subject with ASD, science, math, engineering and engineering related topics for education and training.

It is another object of the present invention, wherein the method and apparatus delivers therapeutic 3D/2D animated learning models to the subjects with autism through the World Wide Web network for autism therapeutic educational intervention.

### SUMMARY OF THE INVENTION

Thus according to basic aspect of the present invention there is provided a computerized method of improving a Subject's cognitive, language and social skills using a series of audio-visual content that are modified by computer processing, the method comprising:
a) providing trial based training using animation combined with sound, the plurality of training skill levels differing from each other in the difficulty of logical constructs, size, complexity of audio-visual presentation of content by a computer;
b) selecting from the different training skill levels, a training skill level for presentation to the Subject that is associated with the Subject's ability to learn the offered topic;
c) presenting via a computer display with touch screen or without touch screen capability having 2D and 3D animated content with audio-visual based instructions, the content delivered using graphical interface being the Subject of the training modified by the computer;
d) presenting audio-visual content via a computer, based on the likings, hobbies, objects used in the daily training at home or in classroom, student's daily usage, habit, tradition, practice, custom, familiarity of the student from a set of the audio-visual content library controlled by the computer from the selected skill level;
e) presenting the audio-visual command and information, directing the Subject to provide response via the touch screen based computer display or other input device where input device is a mouse, keyboard, joy stick, scanning device, sensor, camera;
f) presenting audio-visual reparative content delivered to the Subject till the response from the Subject is received;
g) utilizing video camera and motion detecting device that tracks the body movement of the Subject and deliver new animated audio-visual content with different difficulty level and different content type delivered to the computer display screen;
h) indicating the correct manipulation to the Subject visually if the Subject incorrectly manipulates the at least one of the graphical components;
i) delivering the rewards to the Subject upon completing the assigned lesson based on the Subject's performance and likings;
j) delivering audio-visual content delivered to the computer serving Subject through the wired or wireless local area network or world wide web;
k) recording of the audio-visual content delivered to the Subject in streaming video; and
l) recording of Subject's actual physical movements including eye movements in streaming video,
   wherein the logical constructs direct the Subject to recognize and answer the prompted question through visual commands and information, and
   wherein the training skill levels are measured and configured by the trainer administrator using set of questions on the Subject and the Subject's obtained and targeted skill.

It is another aspect of the present invention, wherein the visual content comprises:
a. animated educational informative content followed by the question for the Subject to measure the understanding on the topic;
b. entertaining visual content using animation and video;
c. interactive games;
d. providing a plurality of stimulus sets; and
e. requiring the Subject to distinguish between the presented target graphical animated image and the presented plurality of distracter images and animation by selecting the target graphical animation associated with the presented command and informational sentence,
   wherein the plurality of stimulus sets comprising Subject's own or family member of any known individual's photograph, animated avatar and cartoon character, and
   wherein each of the plurality of stimulus sets group the plurality of command and informational sentences audio/sound according to the Subject's liking, skill level, difficulty level and trainer administrator's preference.

It is another aspect of the present invention, wherein the audio content comprises:
a. Subject's own voice;
b. Voice of a person known to the Subject;
c. Digitized voice;
d. Other human voice;
e. stretching the speech commands and information in the time domain; and
f. changing the length of the sound by adding blank audio time between words,
   wherein the plurality of training skill levels differ from each other with respect to the amount of stretching of the audio and presentation of the detail in the visual object,
   wherein the modified command and informational sentences differ from each other in the amount of stretching and emphasis applied to the command and informational sentences, and
   wherein each of the plurality of modified command and informational sentences are stretched by the computer in the time domain, between 100% and approximately 300%.

It is another aspect of the present invention, wherein the method further comprising:

upon completion of the trial and based on the score achieved by the Subject, Subject gets rewarded based on the selection made by the Subject or surprised reward based on their likings defined by the trainer administrator or randomly decided by the computer,
wherein the said reward includes a physical object, printed material, toy, food and game.

It is another aspect of the present invention, wherein
a. upon receiving the wrong answer from the Subject, the next visual command and information is delivered on the same training topic with the same difficulty;
b. upon receiving the correct answer from the Subject, the next visual command and information is delivered on the same training topic with increased difficulty; and
c. upon receiving multiple wrong answers from the Subject the next visual command and information is delivered on the same training topic with reduced difficulty,
   wherein the correct and incorrect responses of the graphical components by the Subject are recorded.

It is another aspect of the present invention, wherein the graphical component of the logical construct comprises color, size, density, background, type, method, visual effect and shape.

In another aspect of the present invention there is provided an apparatus for the improvement of the Subject's cognitive, language and social skills that utilizes delivery of audio-video content comprising:

input devices; and
output devices,
wherein the input device comprises of camera, touch screen, identification card, mouse, keyboard, joystick, fingerprint scanner, paper scanner, motion detector, microphone, video camera and motion detector,
wherein the output device further comprising vending machine or dispenser system or printer or combination of multiple delivery systems (output device) connected to the computer through local area network or worldwide web network or directly connected to the computer for immediate dispensing of the reward to the Subject,
wherein the reward delivered to the Subject gets recorded in to the database,
wherein the vending machine mechanism is used for the storage and delivery of the tangible items,
wherein the apparatus delivers audio-video content based on the responses of the Subject to the programmed parameters,
wherein the responses of the Subject is captured using the input devices, recording of video and monitoring of the activities from the Subject,
wherein the apparatus processes the requests from the user and communicates with the artificial intelligence processing unit,
wherein the apparatus receives audio-visual content from the artificial intelligence processing unit stored in the content storage unit based on the parameters set, and
wherein the audio-video content comprises 2D and 3D animation and visual presentation of the plurality of animated images with audio from the content library.

It is another aspect of the present invention, wherein the apparatus receives request to print to the printer connected directly or through the local area network and World Wide Web based on the third-party programmed parameters and to deliver tangible item from the storage directly attached or connected through local area network and World Wide Web based on the parameter set.

It is another aspect of the present invention, wherein the apparatus records: all activities from the monitor;

all trial activities in terms of sessions, history of trials, list of delivered content, responses, delivered tangible and non-tangible items, date and time for all actions and responses in the form of numbers and text; and
the actual body movement and voice in the form of video stream using installed video camera,
wherein the recorded information is sent to the artificial intelligence processing unit for storage.

It is another aspect of the present invention, wherein the monitoring of the activities is done by sending notification of the activity result and activity related information to parties involved with trial using email, fax, instant messenger, text message or SMS.

In another aspect of the present invention there is provided a system for improving a Subject's cognitive, language and social skills using a series of audio-visual content that are modified by computer processing comprising:

centralized database;
one or more apparatus;
one or more printing devices;
one or more artificial intelligence processing unit;
storage unit;
local area network;
world wide web;
one or more output devices; and
one or more trainer administrator administrators,
wherein the apparatus is connected to the artificial intelligence processing unit using the local area network and world wide web for the delivery of the series of audio-visual content for the trial and capture responses from the users,
wherein the printing device is connected to the apparatus either directly or using the local area network and world wide web for obtaining a printed output,
wherein the vending machine is connected for obtaining a tangible item from the storage as an output;
wherein the trainer administrator administrators is connected to the artificial intelligence processing unit through local area network and world wide web to setup the parameters related to the trial management and to monitor, view, compare and analyze data,
wherein the user is connected using any apparatus on the local area network and world wide web to attend assigned trial by the trainer administrator,
wherein the artificial intelligence processing unit comprises of an application server and a web server for the delivery of the animated content with audio visual effects, and
wherein the trainer administrator administrators set the trainer administrator programmed parameters for the user.

It is another aspect of the present invention, wherein the artificial intelligence processing unit is connected to the content storage unit which comprises of databases server for the storage of the data and media server for the storage of the audio-visual content.

It is another aspect of the present invention, wherein the trainer administrator is anyone connected to the system using local area network and World Wide Web.

It is another aspect of the present invention, wherein the system documents all the steps and history of the trial in the centralized database where the recorded data can be retrieved using local area network and World Wide Web.

It is another aspect of the present invention, wherein the delivery of the series of audio-visual content includes sequence, type, recurrence, and length in terms total time, color, volume of the delivered audio-visual content and output type like print, tangible item, audio-visual content, audio-visual interactive content like game.

It is another aspect of the present invention, wherein the trainer administrators can view the recorded information sent to the artificial intelligence processing unit by the apparatus.

### BRIEF DESCRIPTION OF THE DRAWINGS

FIG. 1 is a system diagram of a computer system for executing a program according to the present invention;

FIG. 2 is a process diagram of the method of the training for the present invention;

FIG. 3 is a system dataflow diagram showing flow of the date from various components of the system;

FIG. 4 is a system workflow diagram showing flow of activities in the proposed sequence;

FIG. 5-A is a prototype of a kiosk based apparatus with integrated delivery system to deliver the method of the present invention;

FIG. 5-B is a prototype of a kiosk system with independent unit of the delivery system for the present invention;

FIG. 6 is a flow diagram of the activity delivery process explaining process of user validation to the award delivery;

FIG. 7 illustrates flow diagram explaining delivery of the training activity management based on the performance and the skill level;

FIG. 8 illustrates how the sound will be modified for users at the lower skill level;

FIG. 9 is a pictorial presentation of sample activities;

FIG. 10 illustrates how the system will be utilized in a different environment for delivering same activities at different time;

FIG. 11 illustrates a sample activity of “Touch and Show” title screen;

FIG. 12 illustrates a sample activity “Touch and Show” the teaching training on a selected topic;

FIG. 13-A illustrates a sample activity “Touch and Show” training on how to play the activity using the system and apparatus by utilizing audio and video based instructions;

FIG. 13-B illustrates a sample activity “Touch and Show” training on how to play the activity using the system and apparatus by utilizing only visual presentation using video;

FIG. 14 illustrates the actual activity;

FIG. 15 illustrates a sample successful completion of the activity module using several attempts;

FIG. 16 illustrates score tracking method;

FIG. 17 illustrates a sample visual presentation of the score and reward system;

FIG. 18-A and FIG. 18-B illustrates how the customization can be done for the activity based on the Subject's likings; and

FIG. 19 and FIG. 20 illustrates step by step process of the sample activity.

### DETAILED DESCRIPTION

The present invention as discussed hereinbefore relates to a method and apparatus to improve a subject's learning ability by utilizing a computer/kiosk system and reducing the social the element from the intervention. The method provides a plurality of content type in terms of training skill levels, subject or subject's known individual's avatar or picture, voice, topics of interest and/or content of the subject's interest. This plurality differs from each other in the form of animated content, and in the amount of audio processing applied to the speech commands and/or information. The method also selects from the plurality of content type based on the needs and training skill level to be presented to the subject that is associated with, or corresponds to, the subject's ability.

The method is presented to the Subject on a computer and interacts with the Subject via input/output devices like camera, touch screen, ID card, mouse, keyboard, joystick, fingerprint scanner, paper scanner, motion detector, or any body movement detecting device on the computer. The method utilizes the information from the input devices to calculate the needs of the Subject and change the type, quality, method, color, audio and/or visual presentation delivered to the subject. The method further presents as a trial, an audio/visual commands/information from a set of animation and speech commands/information from the selected skill level. The speech command directs the Subject to manipulate at least one of the pluralities of graphical components. If the Subject correctly manipulates the graphical components, the method presents another trial. If the Subject incorrectly manipulates the graphical components, the method presents another trial without giving any discouraging message. As the Subject correctly manipulates the graphical components, new audio/visual command/information from the set of animation and speech command/information from the library gets delivered to the Subject based on the skill and needs of the subject. And, as the Subject incorrectly manipulates the graphical components, the complexity of the trial using audio/visual commands/information is decreased and the entertaining animated content increased. The method is also an attention span measuring tool. The tool measures the Subject's attention span utilizing a motion detector and reads an eye movement using a video camera. Based on the historical attention span of the object, before the expiration of the attention span the method changes the content type delivered to the Subject from educational content to the entertaining content of the Subject's interest. Once the attention is gained, the method delivers new audio/visual command/information from the set of animation and speech command/information from the library to the Subject.

In another aspect, the present invention provides a method to improve the cognitive processing system of a subject. The method provides a plurality of stimulus sets, with each of the plurality of stimulus sets having a plurality of command/information sentences. The method also provides a plurality of target graphical images and animation, each of the animation associated with a different one of the plurality of command/information sentences. The method further provides a plurality of distracter images that are not associated with the plurality of command/information sentences. The method then presents to the Subject one of the plurality of command/information sentences from one of the plurality of stimulus sets to the subject, the presented sentence modified acoustically, and presents to the Subject a target graphical image, from the plurality of target graphical images, that is associated with the presented command/information sentence. Along with the presented target graphical image the method presents a plurality of distracter images. The Subject is then required to distinguish between the presented target graphical image, and the presented plurality of distracter images by selecting the target graphical image associated with the presented command/information sentence. Upon successful completion of the one or multiple trials, the Subject will be awarded by some object, toy, food, or item of interest. In yet another aspect, the present invention provides an adaptive method to improve a Subject's willingness to learn the offered topic.

The method according to the present invention utilizes a computer to process and present animated content with sound to the Subject. This method utilizes the World Wide Web network or the local area network to retrieve animated content from the content storage server.

The method displays a plurality of animated images on the computer, the graphical images associated with information and/or some activities related to the topic of interest for the Subject. The method associates in pairs the plurality of animated images with particular activity and/or events such that two different animated images are associated with a particular activity and/or event. Upon the Subject's selection of any of the plurality of animated images, its associated activity and/or event is presented. The method then requires the user to discriminate between the presented activities and/or events by sequentially selecting two different graphical images from among the plurality of graphical images, that are associated with the particular activities and/or event. The audio command/information is modified by stretching them in the time domain by varying amounts to make easy to understand for the object. As the Subject correctly remembers the activities and/or event at one skill level, the amount of stretching applied to the audio command/information is reduced. In addition, as the Subject correctly remembers the activities and/or events, the number of animated image pairs presented to the Subject increases, requiring the Subject to better train his/her understanding on the activity.

This 3D Animated Interactive Individualized Therapeutic Learning Technology for Autistic students will effectively utilize realistic colorful 2D/3D animation with individualized attractive audio effect for intervention. This technology driven approach utilizes various interventions and approaches to measure the effectiveness on different child with ASD. The key technology used is an application delivering educational animation inside a touch screen Kiosk system with camera/s that tracks eye and body movement of the Student to achieve bidirectional activities. Teachers set up the individualized training plan and can track the development progress and help the student to communicate better to develop independent daily living skills. This learning tool utilizes the artificial intelligence to help students with learning disabilities and may help improve their social behavior (because the student is not dealing with individual where they have to make eye contact). This technique utilizes the technology to provide consistent training for extended hours in the same environment. By using the repetitive activities with the Student using the Kiosk based system, teachers can collect the data of the behaviors and response from variety of content like different colors, animation, instructions, audio-music and special effects.

In the general education field, the technology is widely utilized but in the area of Autism the technology is underutilized. The model of a Social Learning Pal not only teaches social skills but also helps the researchers collect data for further analytical purposes for the betterment of the students, the families and the teachers.

This dual purpose technological solution is utilized in the following settings:
Schools Providing Education to students with ASD
Research Institutes doing research on Autism
Hospitals and home for parents

According to another aspect, the method is implemented in three phases comprising phase I, phase II and phase III. The key activity during phase I is collecting, populating and verifying subjects' profiles. All the master data for the institute providing this training to the Subject is also populated during this phase. Students' Profile development process is done in three steps.

### 1. Collecting Profile Information Includes:

a. Personal Info such as Name, Parent Name, Date of Birth, Picture etc.
b. Collect photographs of family members and individuals known to the Subject for various activities
c. Contact Info such as Email ID, Telephone, Mobile, Residential Address
d. Current Problem/Disorder Info
e. Existing Abilities/Skills
f. Preferences
g. Phobia/Sensitivities
   2. Input students Profile—The Info gathered in step 1 is fed in the database.
   3. Verifying Profiles—The data fed in the database is verified by the authorities.

The phase II generates institute profile

1. Collecting Institute's Profile Info. Includes
a. Name, Contact, Introduction, Web Address, E-Mail Addresses
b. Name and Details of Support, Teaching Staff
   2. Input Institute Profile—The Info gathered is fed in the database.
   3. Verify Institute Profile—Get the Input data verified by the authorities.

In phase II, the right activities for the Students are selected based on their profile by experts. Once the activities are selected, based on the available and collected profile customization of the activity is programmed and configured. Selecting activity process analyzes the profile and selects the suitable activities for the subject. Selected activity is assigned and programmed in the system to the student after reviewing the individual's profile.

a. Capturing Customization Data—During this stage customized data like pictures of familiar people of the students for the activity—‘Identifying familiar people’, are captured and finalized.
b. Compose and Assign—The Trainer Administrator or Teacher composes and customizes selected activities and assigns it to right student.

Phase III is the final stage of the implementation where the Subject carry out the activities assigned and programmed. Their performance, progress and acceptance are tracked and analyzed. Following steps are followed as part of the implementation:

1. Operational Setup—This includes the installation and set up of required Hardware/Software.
2. The launch—The Students carry out the assigned activities.
3. Tracking—Progress and performance of students is automatically tracked by the application.
4. Feedback Capture—Feedback from the stakeholders (Teachers/Students/Parents) is captured.
5. Analysis and Documentation—The information related to progress and performance of students will be analyzed and the results documented. Similarly the feedback received is also be analyzed and the outcome of this analysis is documented.

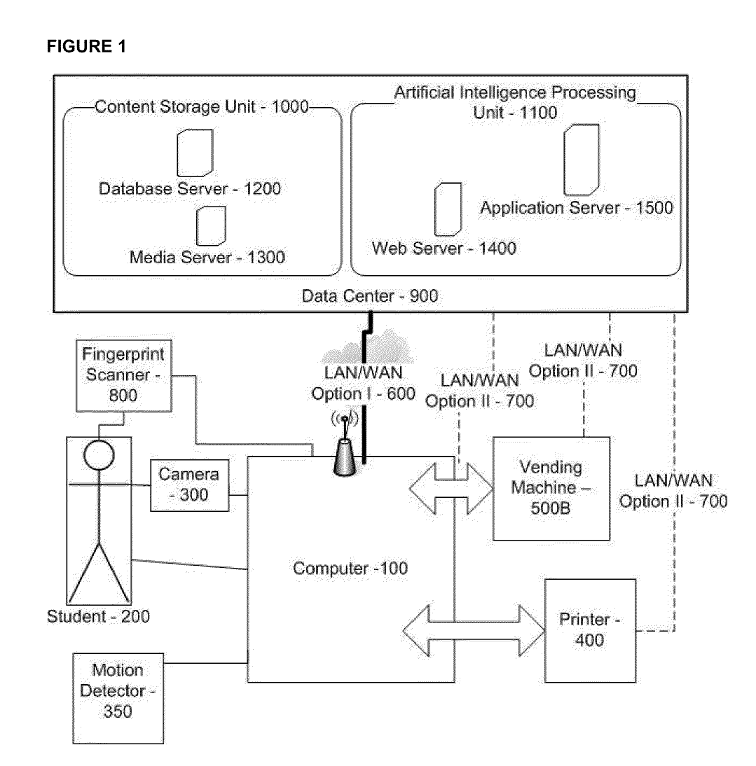

Referring to FIG. 1 is a system diagram comprising a computer system 100 for executing training for the brain development disorder in a subject, according to the present invention. The computer system 100 contains a computer having a CPU, memory (not shown), hard disk (not shown) and CD ROM drive (not shown), attached to a touch screen monitor. The monitor provides visual prompting and feedback to the Subject during execution of the computer program. Also the monitor captures the response from the user using touch screen technology. Attached to the computer are a keyboard, speakers, a mouse, and headphones. The speakers and the headphones provide auditory prompting and feedback to the subject during execution of the computer program. The touch screen is used to navigate through the computer program, and to select particular responses after visual or auditory prompting by the computer program. In some cases mouse is used for the above purpose. The keyboard allows an instructor to enter alpha numeric information about the subject into the computer. Although a number of different computer platforms are applicable to the present invention, embodiments of the present invention execute on either IBM compatible computers or Macintosh computers. The finger print scanner 800 validates the Subject (student) 200 and based on the identity of the Subject load the profile of user in the computer program. The camera 300 tracks the activities of the Subject and records the video for further analysis. The motion detector 350 detects the motion of the Subject. The printer 400 prints the printable rewards and the result of the Subject's progress. A printer 400 is shown connected to the computer 100 to illustrate that a subject can print out reports and rewards associated with the computer program of the present invention.

Vending machine 500B delivers the physical object based reward to the Subject based on the learning program in a computer program. LAN/WAN Option I 600 connects the computer system to the Data center 900 using wireless network and the LAN/WAN option II 700 uses wired network. The computer network allows information such as animated content, test scores, game statistics, and other subject information to flow from and to the subject's computer 100, to a server in the data center 900. Data center 900 contains storage unit 1000 and artificial intelligent processing unit 1100. The storage unit 1000 has two servers Database server 1200 and Media server 1300. These servers are utilized to store the media used by the computer program. This media includes audio, video and text based media for training Artificial intelligence unit 1100 has two servers, web server 1400 and application server 1500. Web server 1400 delivers training content to the Subject using the internet or LAN/WAN network. The application server 1500 generates deliverable content for the web server using the animated audio and video media delivered by the storage unit.

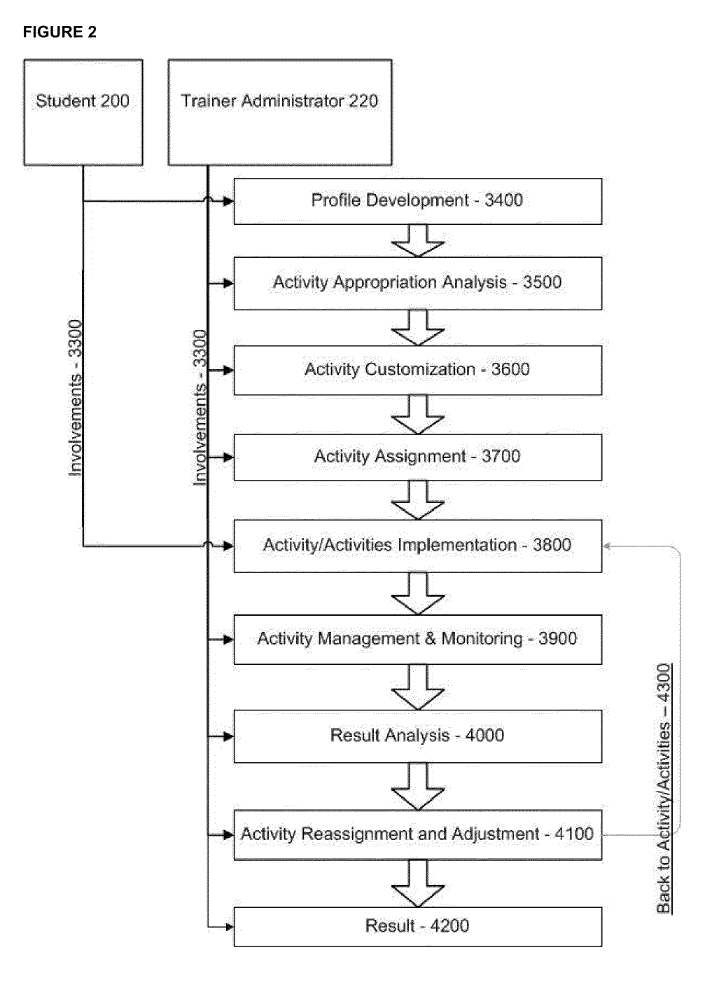

Now referring to FIG. 2, is a method of training The Subject 200 and the Trainer Administrator 220 are involved 3300 with various phases of the method. The Profile Development 3400 phase of the present invention is managed by the Trainer Administrator 220. Trainer Administrator creates the profile of the subject in terms of their likings, disliking, nature, gender, age and family background.

The phase II of the proposed method is the Activity Appropriation Analysis 3500. This is done by the Trainer Administrator. Based on the profile and Subject's knowledge proficiency on the topic, Trainer Administrator creates a lesson plan using the library of the offered activities. Based on the lesson plan developed by the Trainer Administrator, the next phase would be to Activity Customization 3600 for the subject using the library of objects and audio visual components to develop customized activity. The Activity Assignment 3700 phase assigns the assignment activity to the Subject for implementation. In this phase the Subject is scheduled for training using the assigned activities in an activity module form. Multiple activities are assigned in an activity module form to the Subject for scheduled delivery on a daily basis. The Trainer Administrator reviews the information on a computer and can upload configuration and control information pertaining to a particular subject. The Activity Implementation 3800 phase is the actual execution of the planed activity under the supervision of the Trainer Administrator. In the Activity Implementation phase 3800, Subject uses the proposed software program on a daily basis for a planed fix time. Based on the programmed profile and assigned assignment, the Subject goes to the next level of complexity and type of the activity. Once all the activity assigned are successfully completed based on the programmed parameters, the Subject gets graduated for the assigned activity module. Throughout the Activity Implementation 3800 phase, the Trainer Administrator manages and monitors the progress of the Subject using the opposed computer program. This phase is the Activity Managing and Monitoring phase 3900. The Result Analysis 4000 and Activity reassignment and adjustment 4100 get the Subject to the final Result 4200.

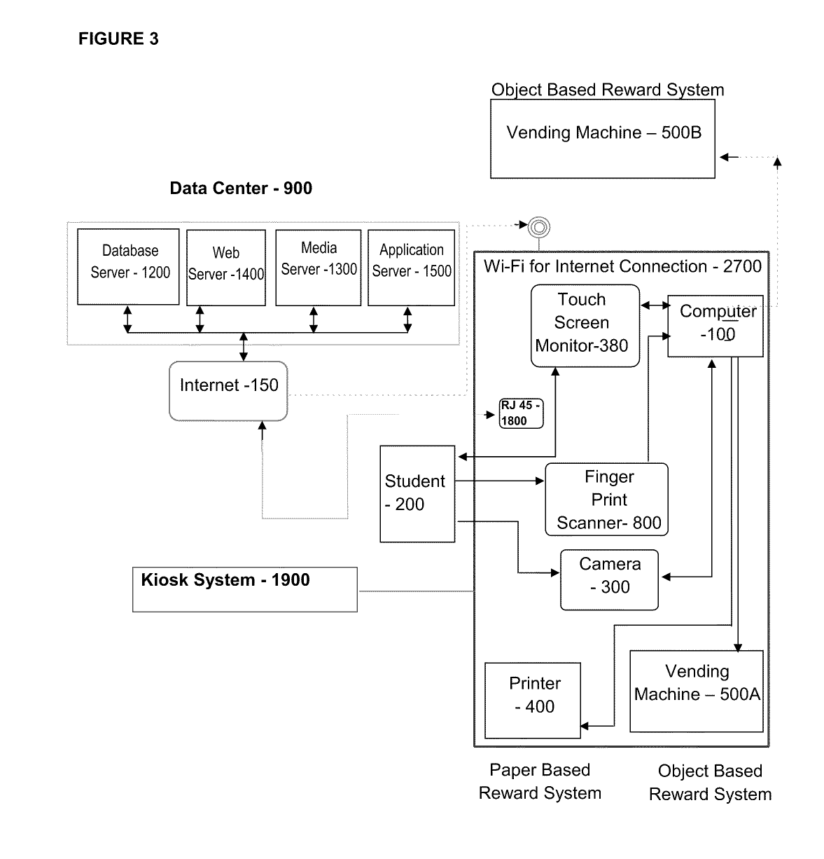

Referring to FIG. 3 is a system data flow diagram that illustrates the data flowing between the student Subject and the proposed apparatus for training. Student 200 sends the finger print information to the fingerprint scanner 800. The finger print scanner 800 sends the captured data to the CPU. The CPU is connected to the data center 900 through internet 150. Using the internet connection CPU sends request to the web server 1400 in the data center 900 for the user validation. Request from the web server 1400 send request to the application server 1500 which sends request to the database server 1200 for user validation. Upon the successful validation of the user, the message gets delivered to the CPU. The delivered message from the CPU gets displayed on the touch screen monitor 380. Based on the configuration of the activity assigned to the subject, content gets delivered to the touch screen monitor 380 by the web server 1400 and the media server 1300. Camera 300 monitors the movement of the Subject (student) 200 and the motion gets recorded in to the CPU which gets transferred and stored to the server 1300.

Upon completion of the activity, CPU gets request from the application server 1500 to deliver the reward to the Subject. Based on the request received from the application server 1500, the request to the printer 400 or object based reward system or object based reward system gets transferred for the reward delivery to the subject.

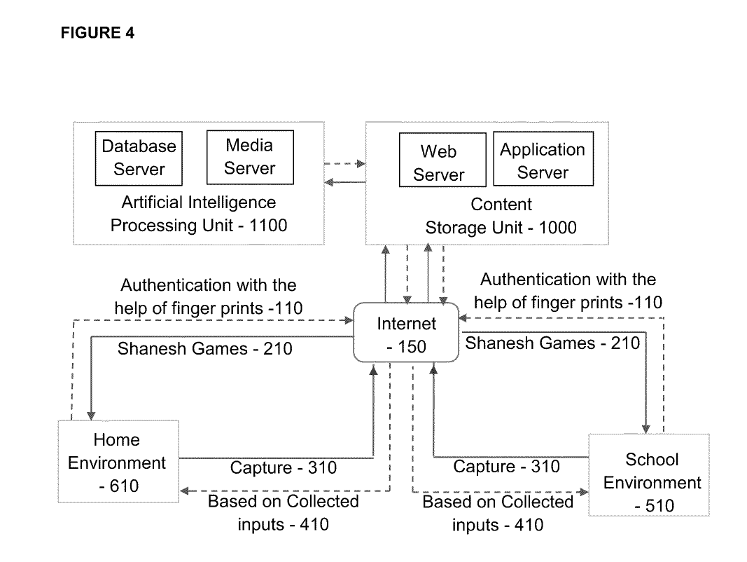

Referring to FIG. 4 is a workflow diagram that illustrates the step by step work flow. Step 1 is the authentication 110 using the login screen or using biometric technology. The date gets transmitted to Web server 1400 and Application server 1500 using the internet 150. Upon successful authentication of step 2, the assigned activity with the assigned training and entertaining content 210 starts delivering to the Subject. The Subject's (student) input using the input devices like touch screen, keyboard and mouse along with the movement of the Subject using the camera is captured 310 and delivered to the Web server 1400 and Application server 1500 in the step 3. In step 4, based on the input 410 collected from the Subject, the response, more content, report, result, animated customized content is delivered. Home environment 610 and school environment 510 shows the same activity and activity modules are accessed from the different location using the different hardware device using internet 150. If the Subject is using the system from the home environment 610 where the object based reward system as illustrated in the FIG. 3 is not available, the Subject will have an ability to print the credit for reward using any printer connected or save the credit proof for the future claim with the Trainer Administrator for their reward.

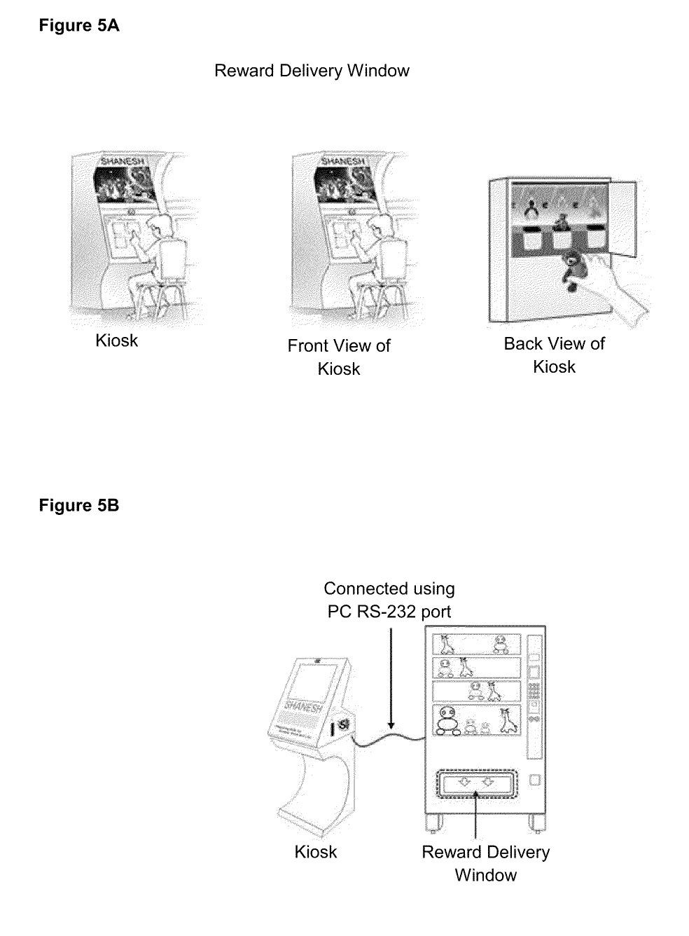

Reference is then invited to FIG. 5-A that illustrates the prototype of a Kiosk based apparatus. The Kiosk system comprise of CPU, touch screen monitor, camera, fingerprint scanner, network interface card, printer and machine for the delivery of the physical object for the reward delivery mechanism. The Kiosk system has an open slot in the front for the delivery of the reward. In the back of the apparatus there is a window for loading and unloading the physical object for the reward.

Referring to FIG. 5-B that illustrates the prototype of the Kiosk system with delivery machine connected through the RS-232 port. The Kiosk system is connected through the RS-232 port to the delivery machine with a reward delivery window. The reward delivery machine has object loading window in the back of the cabinet similar to the FIG. 5-A. For a large size user group, this type of the model is used where more objects like toys, candy, food or any tangible item based on the liking of the Subject is stored and displayed. Based on the likings of the Subject (student), Trainer Administrator load these tangible items in the delivery machine, which is delivered to the Subject upon meeting the performance criteria set by the Trainer Administrator. Based on the settings set by the Trainer Administrator, the Subject selects the desired item from the delivery machine as a reward. In some case, based on the Trainer Administrator's set preferences the item is visible or not visible to the subject where Trainer Administrator wants to keep the reward surprise to the subject. The system of the present invention also uses the printer and delivery system connected to the network. Based on the parameters set by the Trainer Administrator, the system prints the printable reward on the attached printer.

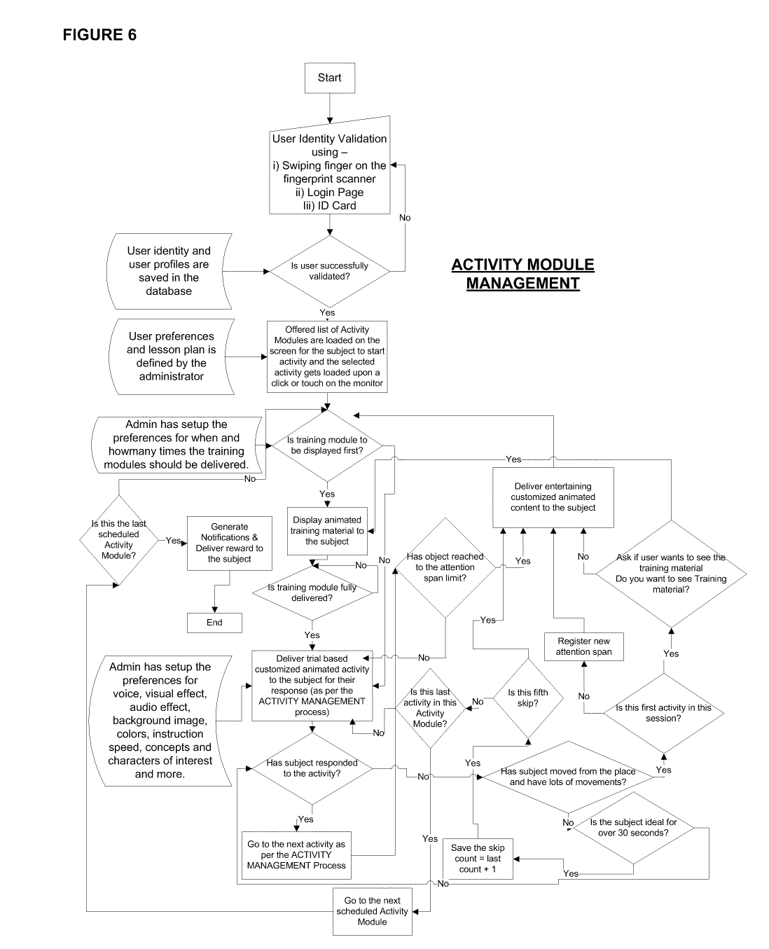

Reference is then made to FIG. 6 that illustrates the flow diagram of an activity module management process. User swipe the figure on the finger print scanning device or ID card or login using the login ID and password using the graphical user interface delivered on a touch screen monitor. Trainer Administrator has created and saved users profile in the database for validation. Upon successful validation the activity modules gets loaded on the users screen. First activity module gets loaded from the list of the activities modules assigned to the subject by the Trainer Administrator. First check is to see if there is a need of delivering training material related to the loaded activity module. If the training material is configured by the Trainer Administrator, the animated training material using the audio visual effect gets delivered. This training material is customized for the Subject based on the profile and customized content programmed for the Subject. After completion of the training module, the trial based activity from the activity list for the selected module gets delivered to the subject. After the delivery of the content, system waits for the response from the Subject. While waiting, the system monitors the subject's movement using the video motion detector. If the user has moved from his place and if this is the first activity in this session, system asks subject if there is an interest in reviewing the training material again. If the response is no or is there is no response from the user, system will deliver some entertaining content to the subject. At the end of the entertaining content, the next module gets loaded for the next delivery. If the user requests for the training material, the training material for the active activity module gets loaded. If this is not the first activity and motion gets detected after the delivery of the activity without any response, the new attention span gets registered. When the response to the activity is received and before going to the next activity, attention span gets checked. If the attention span of the subject is reached in this session, the entertaining content gets delivered to the subject and the session time gets reset for the delivery of the next activity. After delivery of the activity, if the subject is idle for over 30 seconds without any movement, the next activity in the module gets delivered. If there are 5 skips in the current session, the entertaining content gets delivered to grab the attention of the subject. When the last activity gets delivered to the user, the system loads the next activity module from the assigned modules. If all modules are delivered successfully, the system delivers visual, printed or object based reward to the object. Upon successful completion of the activity module the system will sent notifications to all the individuals involved with the training including Training Administrators by email, text or instant messenger tool. System utilizes off-the-shelf instant messaging technology customized and integrated to this system for instant notification of rewards.

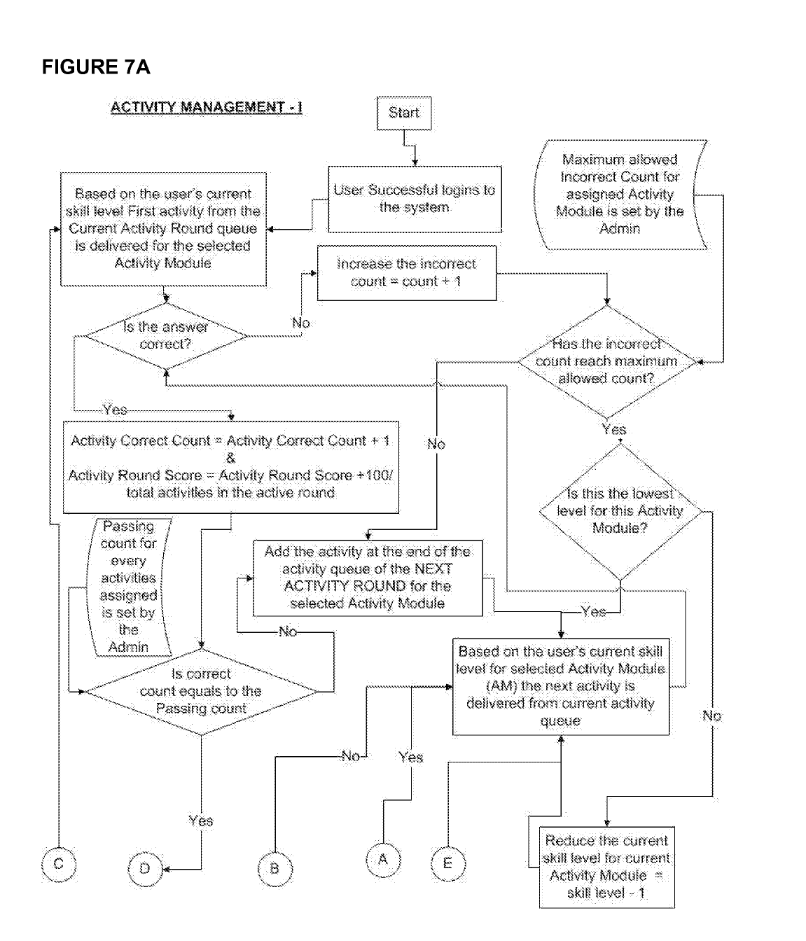

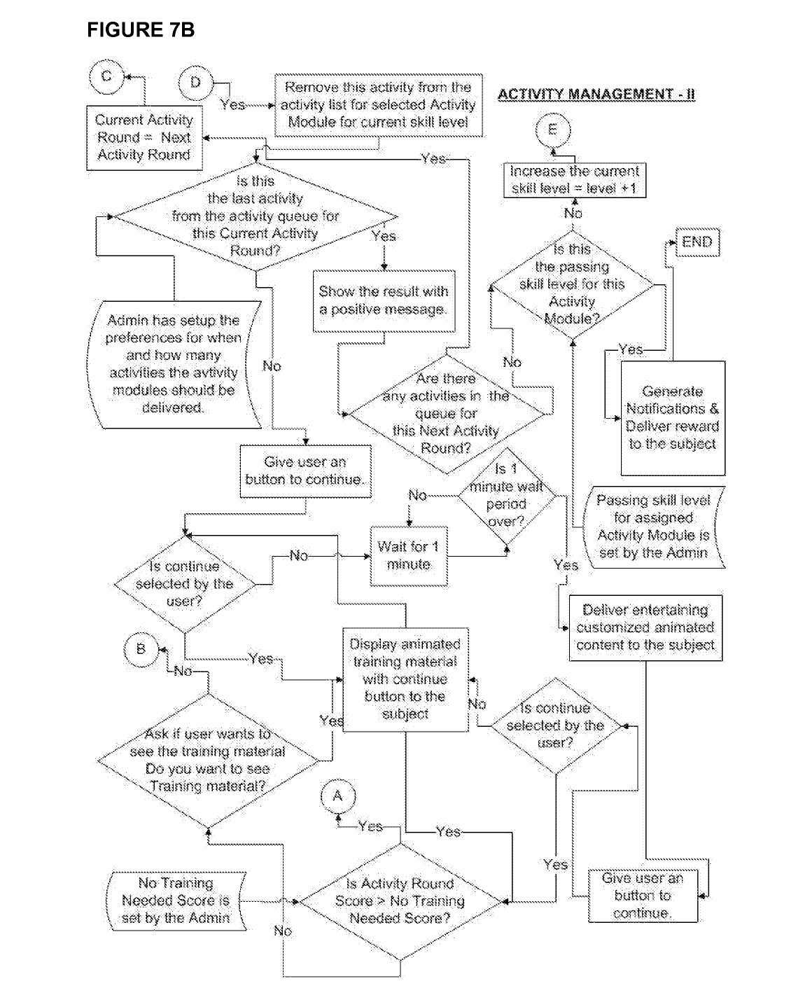

Reference is then made to FIG. 7 that illustrates the flow diagram of activity management and skill level management process for the activity module. After the successful login to the system, the first activity module from the assigned modules gets loaded. The default first skill level for the current activity module is used to deliver the first activity from the activity module. If the answer is incorrect, the incorrect count gets incremented by one till it reaches to the maximum incorrect allowed for the current activity module. Once it reaches the maximum allowed incorrect answers for the current module, system changes the skill level to one skill level down for the module. The incorrect activity gets added for the next round of the activity for the same skill level. If the answer is correct, the correct count for this activity gets incremented till it reaches to the passing count for this activity. When it reaches to the passing count, the activity gets removed from the current activity module for the current level. If this is the last activity for this round, next activity round gets loaded.

After end of the each activity round, the activity round score is checked against the No Training Needed count. If the Activity round score is greater than No Training Needed count, the training content delivery is skipped. After end of the each activity, if continue is not selected by the subject, after 1 minute entertaining customized animation is delivered to get the attention of the subject. When the activity round is finished with all activities successfully removed from the current skill level and maximum passing skill level is reached, the reward is delivered to the subject.

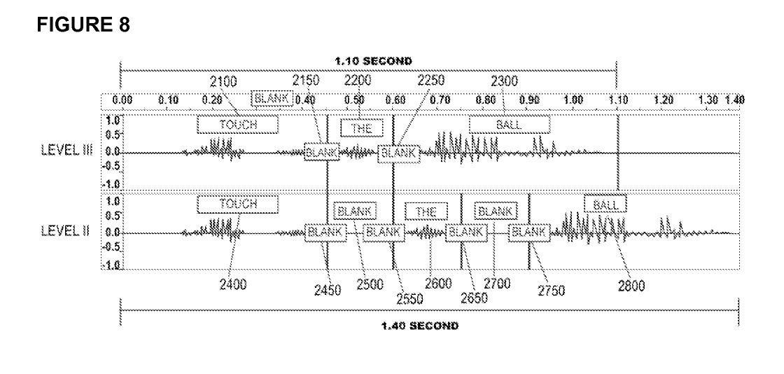

Reference is then made to FIG. 8 that illustrates the method of customization of sound for lower level skill. The instructional and informative educational audio gets stored in the database in pieces like TOUCH 2100, THE 2200 and BALL 2300. For Level III the voice will be the natural voice which will have each word separated by 0.06 seconds. The BLANK 2150 indicates default separation of 0.06 seconds between two words. For the lower level complexity of Level II and Level I, additional BLANK 2500 and BLANK 2700 are inserted to make the information easy to understand for the Subject. These additional BLANK (2500 and 2700) are of 0.1 seconds. FIG. 8 illustrates Level III and Level II examples. FIG. 8 illustrates, by utilizing this method the original time span for the “TOUCH THE BALL” will get extended from the 1.10 seconds to 1.40 seconds.

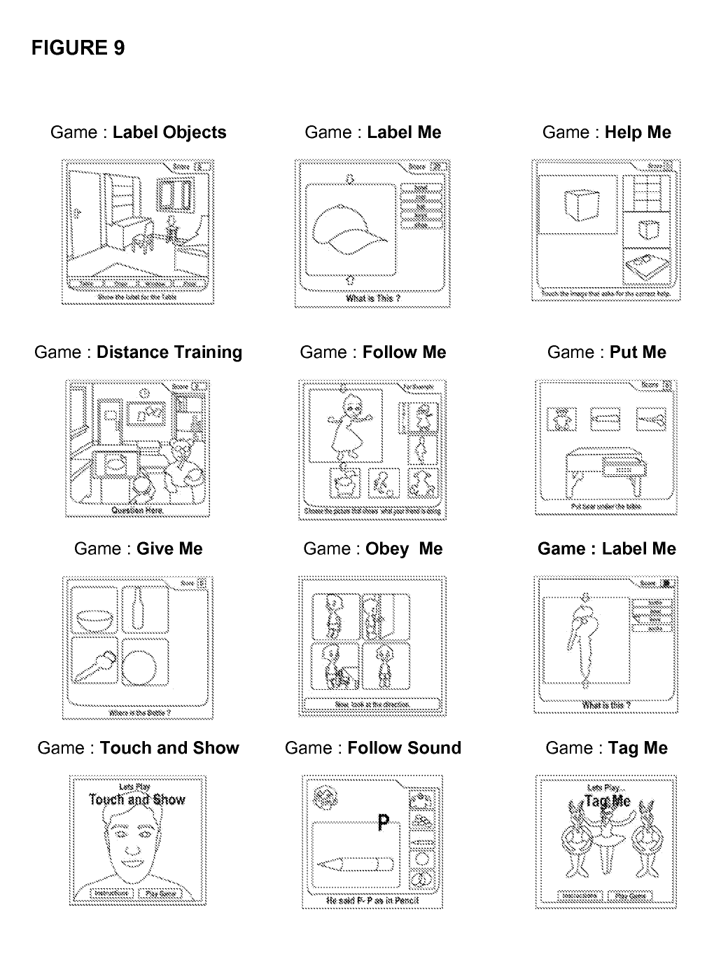

Reference is then made to FIG. 9 that illustrates pictorial presentation of some of the sample activities. Listed screens show activities of Label Objects, Label Me, Help Me, Distance Training, Follow Me, Put Me, Give Me, Touch and Show, Follow Sound and Tag Me.

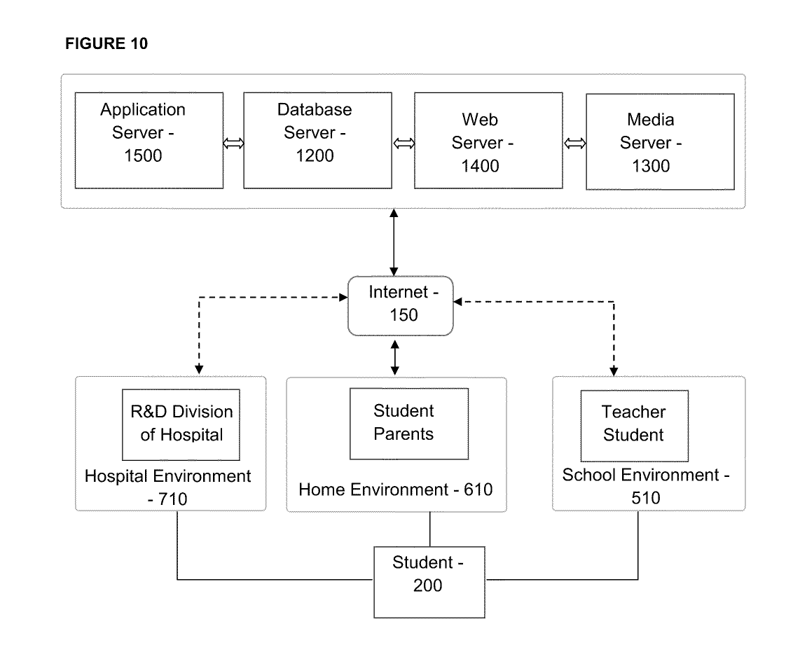

Referring to FIG. 10 that illustrates the utilization of the system and how the same Subject uses the same Activity Modules from different locations by utilizing different hardware. The Subject 200 uses the same database server 1200 and media server 1300 to get the training from different locations and populate the data in a centralized place in a data center 900.

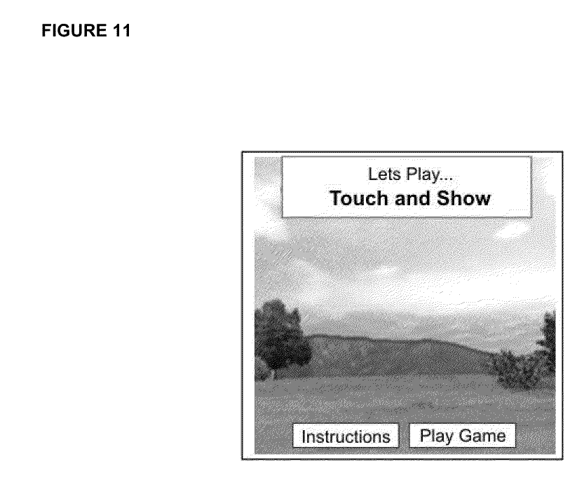

FIG. 11 illustrates a sample activity “Touch and Show” title screen. Based on the Subject's skill level when the activity gets loaded, the first screen shows the activity title screen. For the level I, activity and the training is automatically loaded in full screen and Subject would not have to click on the options shown in the FIG. 11. For the Level II and Level III users the ‘Title Screen’ as shown in the FIG. 11 will be displayed. The Subject has to click or touch on the ‘Play’ button to start the activity.

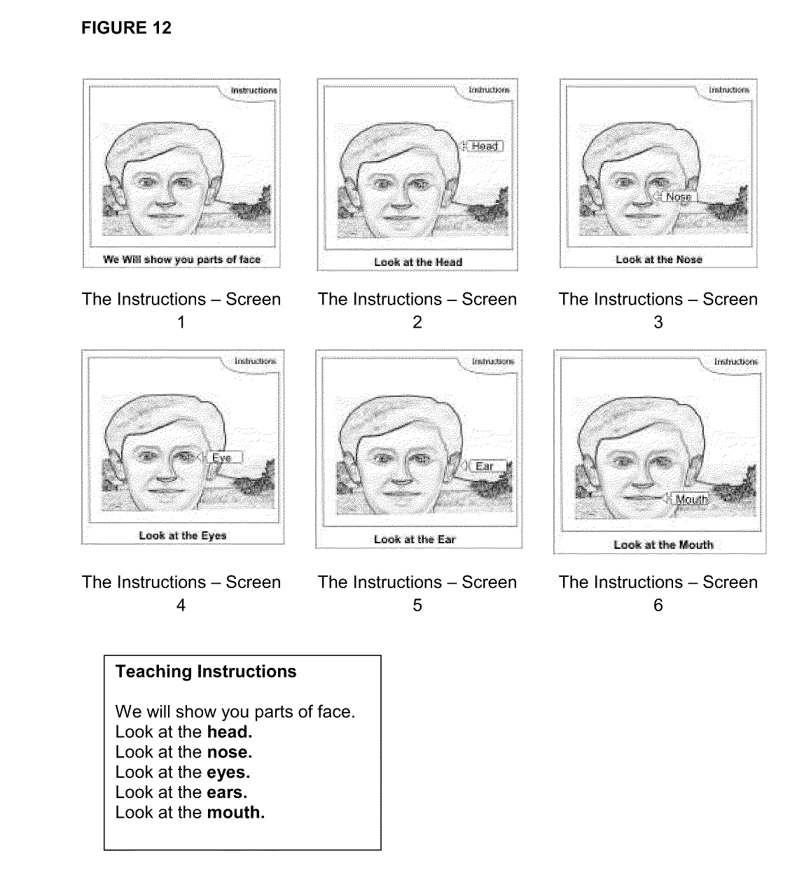

FIG. 12 illustrates teaching instructions on training to the subject for the topic of training for a sample activity “Touch and Show”. Before the activity begins, the animated training is provided to the Subject using the audio visual presentation of the topic of training FIG. 12 illustrates teaching Instructions Examples; Screen 1 illustrates how different parts of the face are shown to the Subject. The audio instructions are delivered in the screen 1 to the subject along with the visual instructions using text. Screen 2 illustrates how the body part is highlighted and audio instruction “Look at the head” is delivered to the subject. Screen 3 illustrates the nose highlighted with arrow, the audio “Look at the nose” and visual instructions delivered to the Subject. Screen 4, Screen 5 and Screen 6 illustrates other body parts for training

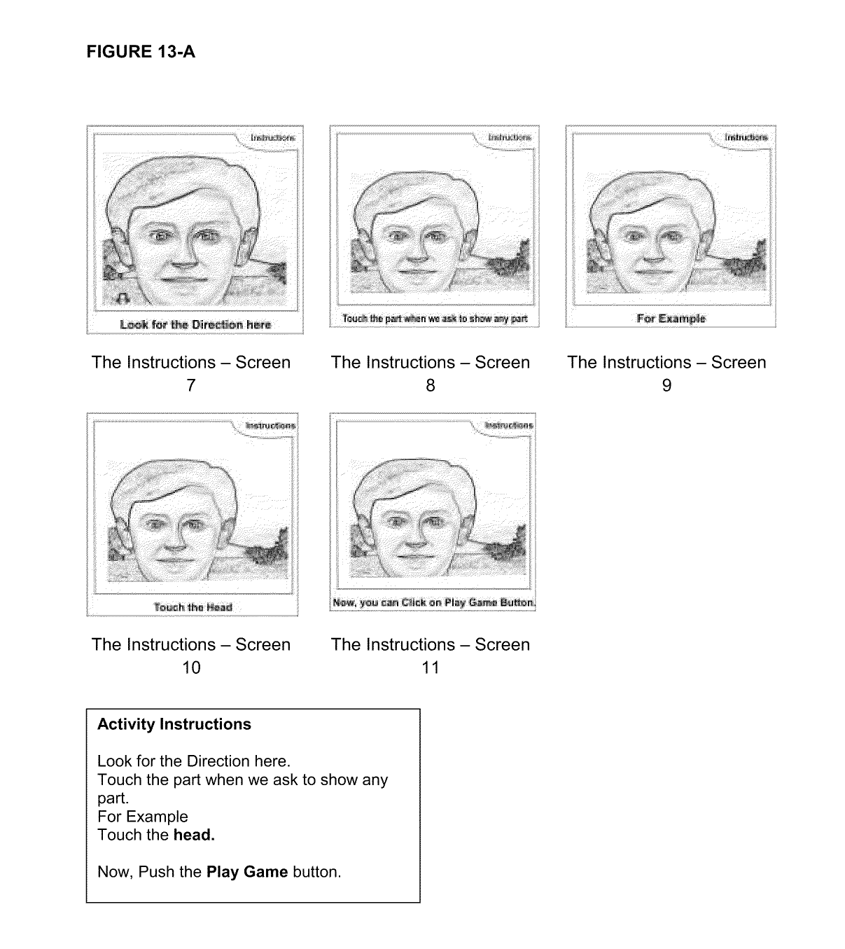

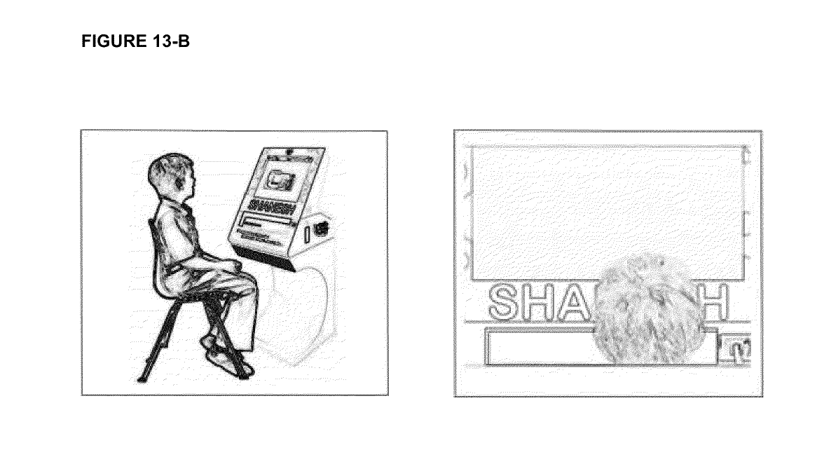

FIG. 13 illustrates activity training instructions on how to carry on the activity using the computer and touch screen monitor for a sample activity “Touch and Show”. Screen 7 illustrates where the directions are displayed with audio “Look for the Direction here” with text based instruction. Screen 8, 9, 10 and 11 illustrates instructions on how to respond to the activity. These instructions are delivered using visual and audio presentation to the object using text on the screen.

FIG. 13-B illustrates activity training instructions screens on how to carry on the activity using the computer and touch screen monitor for a sample activity “Touch and Show”. These instructions are delivered to the subject using different model of visual presentation with audio delivered in an animated video form where the example of the actual user is visually shown playing and following instructions and responding to the activity. In this method of the training, the example shows the child playing the activity and following instructions.

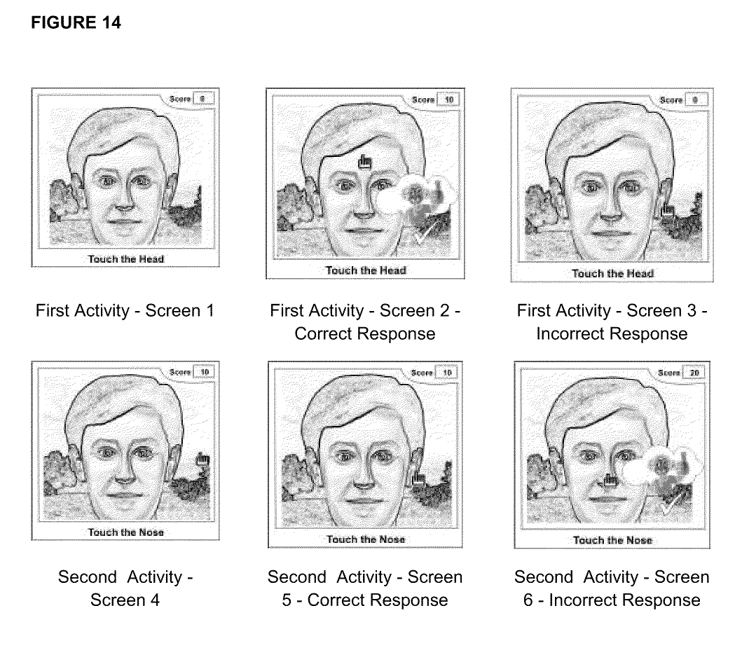

FIG. 14 illustrates the sample activity “Touch and Show”. Screen 1 illustrate the questions asked to the Subject and screen 2 shows how the correct answer is recognized by encouraging animation with audio visual effect. Screen 3 illustrates how the incorrect answer is ignored and the next activity is delivered without any negative response from the training. In the example, the instruction to carry out the first activity—Touch the Head—is shown at the bottom. As shown in FIG. 14 when the subject responds correctly—(a) an animation cheering the player is played and (b) the score points are incremented by a preset value. If the student is unable to finish the activity successfully then an audio message is played. The procedure to carry out the second or remaining number of activities stays same as that of the first activity. FIG. 14 portrays procedure to carry out the second activity—Touch the Nose. The Instructions for remaining activities in this example are—Touch the Eye, Touch the Ear, Touch the Mouth.

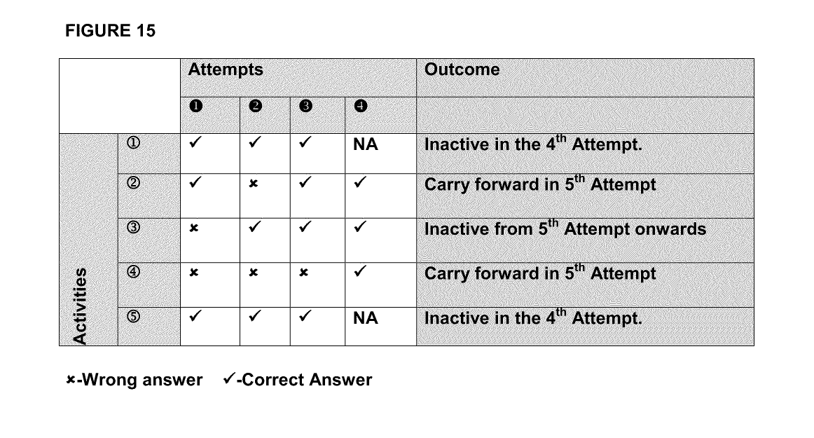

Reference is then invited to FIG. 15 that illustrates example of attempts taken by the subject to complete the sample activity “Touch and Show”. A student successfully completes an Activity, if—1) all activities in the module are mastered or 2) the completion criteria are met. An activity is mastered if the criteria as set by the instructor are satisfied. In the example, there are 5 numbers of activities. Each activity is mastered upon 3 times correct responses provided by the subject. Table 1 illustrates few sample cases. Each column from the second column onwards illustrates an attempt. First column contain the number of activity. The attempts and activities in a row form a case. The outcome in each case is shown in the last column. If there are 3 consecutive correct responses to an activity, it is removed from the assigned activity list on subsequent attempts. Table 1 illustrates Sample Cases where assigned activities are five and the number correct response expected from the subject for each activity is three. After three successful correct answers the activity gets removed from the activity module. As can be seen from the first row of the table since there are 3 consecutive correct responses to Activity 1, this activity is removed from 4^{th} Attempt onwards. Same is the case with Activity 5. The outcome for all the cases is put in the Outcome column.

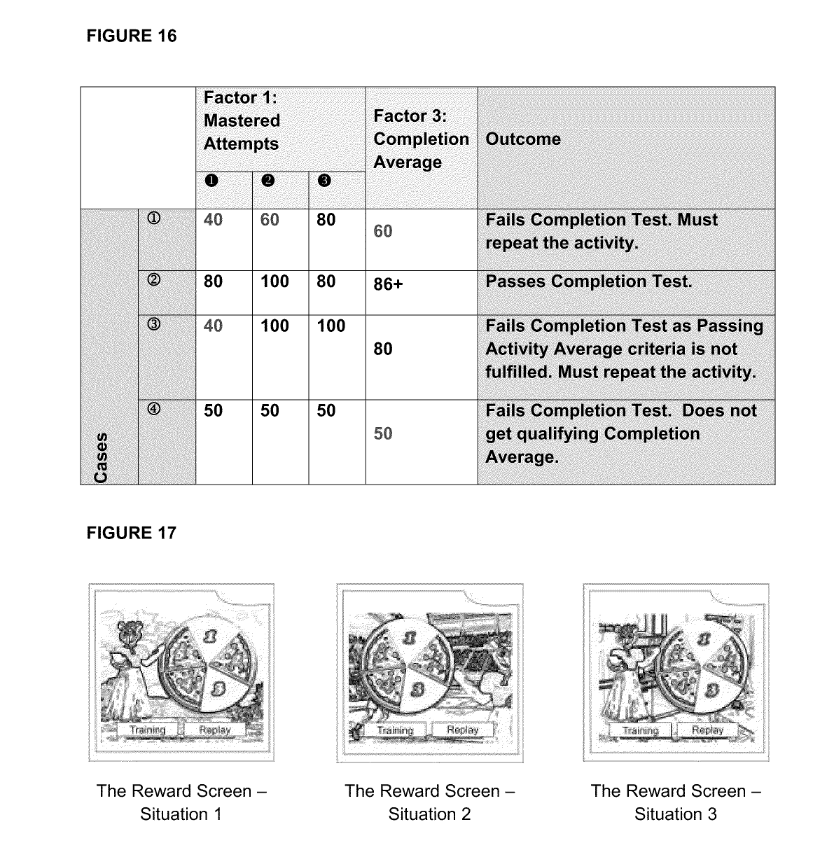

Reference is then invited to FIG. 16 that illustrates how the score is tracked for the successful completion of the assigned module to the Subject. In all, there would be as many attempts as required to master all the 5 assigned activities. An average in percentage of these attempts is recorded. This is the Activity Average score. The completion criteria include three factors—Factor 1: Number of Mastered Attempts to be tracked, Factor 2: Passing Activity Average in Percentage, Factor 3: Qualifying Completion Average in Percentage. The example assumes the value for factor 1 is 3 and that for factor 2 is 50 and factor 3 is 80.

Referring to FIG. 17 illustrates the reward screen at the end of the activity module. The score points or rewards achieved are presented displayed in a graphical form. FIG. 4 show ‘Reward Screens’ under various situations. The accompanying animation explains the rewards obtained for each successful activity. In this example, the Subject gets one pizza slice for each correct response. Since the activities 2, 4 and 5 are successfully completed, the cumulative count is 3. The replay button starts the activity all over again. The training button replays the training part once again.

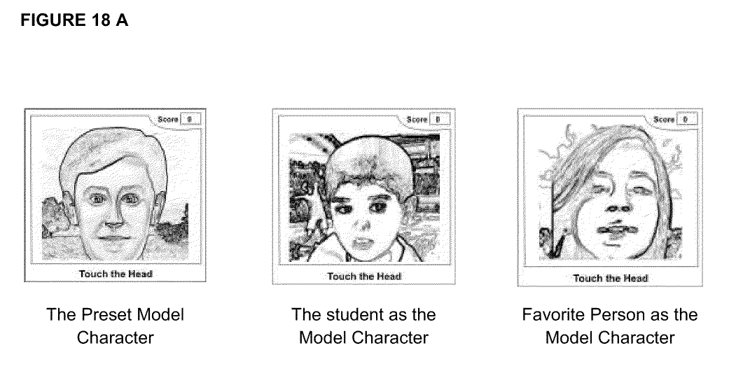

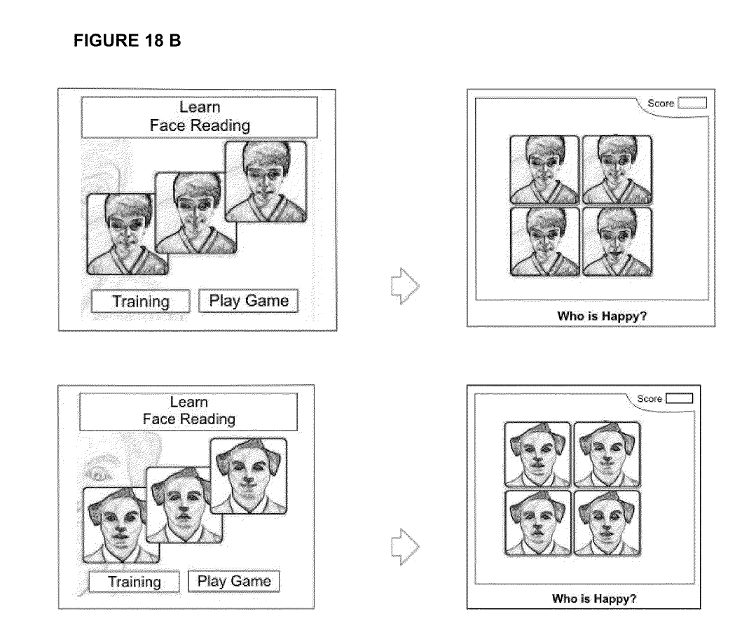

FIG. 18-A illustrates an example of how the activity gets customized by the Trainer Administrator based on the student's likings Each activity module can be customized to suit an individual's preferences and needs. For example if the subject has an affinity for sports Tennis, the background can be set to that of a tennis court. FIG. 18 illustrates different backgrounds with different object for the same activity. Once the student has mastered the activity in the existing set up, the set up can be changed by the Trainer Administrator. This method is utilized to assess student's performance in diverse environment. For example, the model character in this activity module can be—(a) The Preset picture of a character, (b) Subject themselves or (c) one of subject's favorite person. FIG. 18-B illustrates an example of an activity where the image in the activity is replaced by the system with the image or photo of the computer generated character or actual picture of the person based on the Subject's likings.

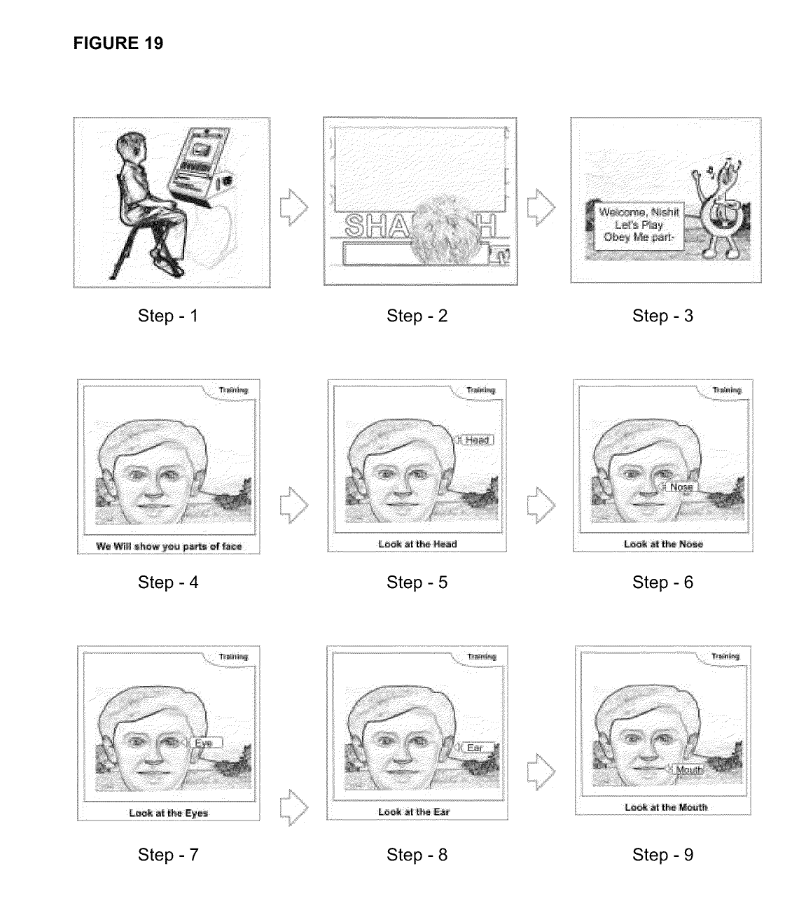

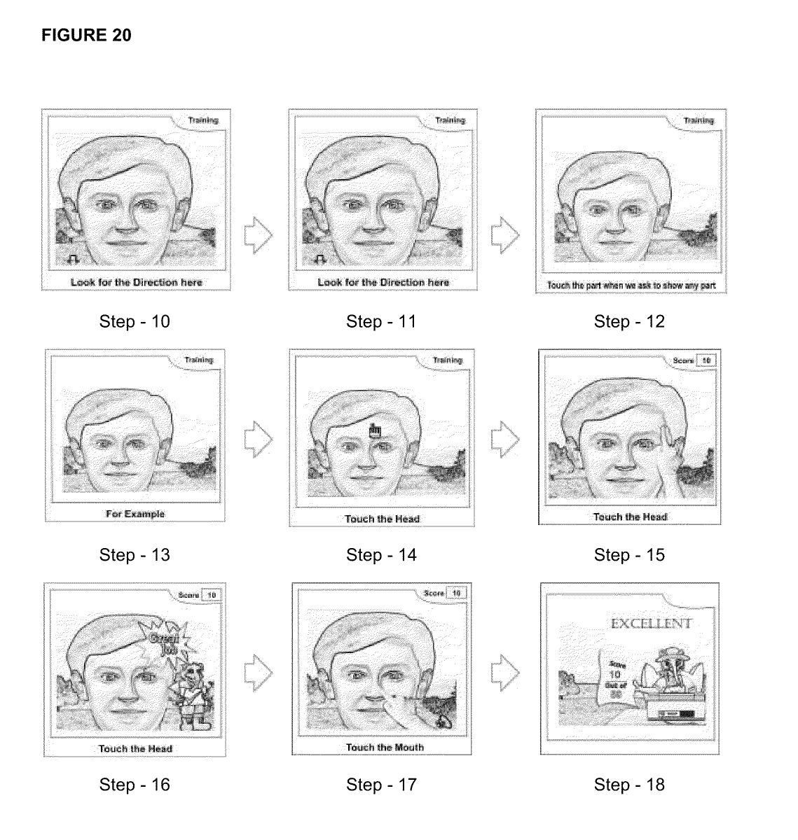

Reference is then invited to FIG. 19 and FIG. 20 that illustrates the step by step actions performed by the Subject to complete the assigned activity on the Kiosk based touch screen system. Step 1 illustrates the Subject sitting in front of the kiosk system. Step 2 illustrates the Subject validating the access to the system using finger print scanning device. Step 3 shows the introductory entertaining animated content with audio is delivered to the Subject. Step 4 to Step 14 illustrates the training material delivered to the Subject using the visual and audio presentation of the content. Step 15 to 17 illustrates the actual activity attended by the Subject and step 18 illustrates the animated result score presented to the Subject.

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

It is thus possible by way of the present invention to provide a method and apparatus to improve a Subject's learning ability by utilizing a computer/kiosk system and reducing the social the element from the intervention. The method provides consistency in the environment at different locations of home, school, hospital, or any place where the computer or kiosk system is installed and delivers repeated educational material customized or personalized for the subject.

I claim:

1. A computerized method of improving a Subject's cognitive, language and social skills using a series of audio-visual content that are modified by computer processing, the method comprising:
a) providing trial based training using animation combined with sound, the plurality of training skill levels differing from each other in the difficulty of logical constructs, size, complexity of audio-visual presentation of content by a computer;
b) selecting from the different training skill levels, a training skill level for presentation to the Subject that is associated with the Subject's ability to learn the offered topic;
c) presenting via a computer display with touch screen or without touch screen capability having 2D and 3D animated content with audio-visual based instructions, the content delivered using graphical interface being the Subject of the training modified by the computer;
d) presenting audio-visual content via a computer, based on the likings, hobbies, objects used in the daily training at home or in classroom, student's daily usage, habit, tradition, practice, custom, familiarity of the student from a set of the audio-visual content library controlled by the computer from the selected skill level;
e) presenting the audio-visual command and information, directing the Subject to provide response via the touch screen based computer display or other input device where input device is a mouse, keyboard, joy stick, scanning device, sensor, camera;
f) presenting audio-visual reparative content delivered to the Subject till the response from the Subject is received;
g) utilizing video camera and motion detecting device that tracks the body movement of the Subject and deliver new animated audio-visual content with different difficulty level and different content type delivered to the computer display screen;
h) indicating the correct manipulation to the Subject visually if the Subject incorrectly manipulates the at least one of the graphical components;
i) delivering the rewards to the Subject upon completing the assigned lesson based on the Subject's performance and likings;
j) delivering audio-visual content delivered to the computer serving Subject through the wired or wireless local area network or world wide web;
k) recording of the audio-visual content delivered to the Subject in streaming video; and
l) recording of Subject's actual physical movements including eye movements in streaming video,
wherein the logical constructs direct the Subject to recognize and answer the prompted question through visual commands and information, and
wherein the training skill levels are measured and configured by the trainer administrator using set of questions on the Subject and the Subject's obtained and targeted skill.

2. The computerized method as claimed in claim 1, wherein the visual content comprises:
a. animated educational informative content followed by the question for the Subject to measure the understanding on the topic;
b. entertaining visual content using animation and video;
c. interactive games;
d. providing a plurality of stimulus sets; and
e. requiring the Subject to distinguish between the presented target graphical animated image and the presented plurality of distracter images and animation by selecting the target graphical animation associated with the presented command and informational sentence,
wherein the plurality of stimulus sets comprising Subject's own or family member of any known individual's photograph, animated avatar and cartoon character, and
wherein each of the plurality of stimulus sets group the plurality of command and informational sentences audio/sound according to the Subject's liking, skill level, difficulty level and trainer administrator's preference.

3. The computerized method as claimed in claim 1, wherein the audio content comprises:
a. Subject's own voice;
b. Voice of a person known to the Subject;
c. Digitized voice;
d. Other human voice;
e. Stretching the speech commands and information in the time domain; and
f. Changing the length of the sound by adding blank audio time between words,
wherein the plurality of training skill levels differ from each other with respect to the amount of stretching of the audio and presentation of the detail in the visual object,
wherein the modified command and informational sentences differ from each other in the amount of stretching and emphasis applied to the command and informational sentences, and
wherein each of the plurality of modified command and informational sentences are stretched by the computer in the time domain, between 100% and approximately 300%.

4. The computerized method as claimed in claim 2, further comprising:
upon completion of the trial and based on the score achieved by the Subject, Subject gets rewarded based on the selection made by the Subject or surprised reward based on their likings defined by the trainer administrator or randomly decided by the computer,
wherein the said reward includes a physical object, printed material, toy, food and game.

5. The computerized method as claimed in claim 1, wherein
a. upon receiving the wrong answer from the Subject, the next visual command and information is delivered on the same training topic with the same difficulty;
b. upon receiving the correct answer from the Subject, the next visual command and information is delivered on the same training topic with increased difficulty; and
c. upon receiving multiple wrong answers from the Subject the next visual command and information is delivered on the same training topic with reduced difficulty,
wherein the correct and incorrect responses of the graphical components by the Subject are recorded.

6. The computerized method as claimed in claim 1, wherein the graphical component of the logical construct comprises color, size, density, background, type, method, visual effect and shape.

7. An apparatus for the improvement of the Subject's cognitive, language and social skills that utilizes delivery of audio-video content comprising:
input devices; and
output devices,
wherein the input device comprises of camera, touch screen, identification card, mouse, keyboard, joystick, fingerprint scanner, paper scanner, motion detector, microphone, video camera and motion detector,
wherein the output device further comprising vending machine or dispenser system or printer or combination of multiple delivery systems (output device) connected to the computer through local area network or worldwide web network or directly connected to the computer for immediate dispensing of the reward to the Subject,
wherein the reward delivered to the Subject gets recorded in to the database,
wherein the vending machine mechanism is used for the storage and delivery of the tangible items,
wherein the apparatus delivers audio-video content based on the responses of the Subject to the programmed parameters,
wherein the responses of the Subject is captured using the input devices, recording of video and monitoring of the activities from the Subject,
wherein the apparatus processes the requests from the user and communicates with the artificial intelligence processing unit,
wherein the apparatus receives audio-visual content from the artificial intelligence processing unit stored in the content storage unit based on the parameters set, and
wherein the audio-video content comprises 2D and 3D animation and visual presentation of the plurality of animated images with audio from the content library.

8. The apparatus as claimed in claim 7 wherein the apparatus can receive a request to print to the printer connected directly or through the local area network and World Wide Web based on the third-party programmed parameters and to deliver tangible item from the storage directly attached or connected through local area network and World Wide Web based on the parameter set.

9. The apparatus as claimed in claim 7 wherein the apparatus can record information, including:
all activities from the monitor;
all trial activities in terms of sessions, history of trials, list of delivered content, responses, delivered tangible and non-tangible items, date and time for all actions and responses in the form of numbers and text; and
the actual body movement and voice in the form of video stream using installed video camera,
wherein the recorded information is sent to the artificial intelligence processing unit for storage.

10. The apparatus as claimed in claim 7, wherein the monitoring of the activities is done by sending notification of the activity result and activity related information to parties involved with trial using email, fax, instant messenger, text message or SMS.

11. A system for improving a Subject's cognitive, language and social skills using a series of audio-visual content that are modified by computer processing comprising:
centralized database;
one or more apparatus;
one or more printing devices;
one or more artificial intelligence processing unit;
storage unit;
local area network;
world wide web;
one or more output devices; and
one or more trainer administrator administrators,
wherein the apparatus is connected to the artificial intelligence processing unit using the local area network and world wide web for the delivery of the series of audio-visual content for the trial and capture responses from the users,
wherein the printing device is connected to the apparatus either directly or using the local area network and world wide web for obtaining a printed output,
wherein the vending machine is connected for obtaining a tangible item from the storage as an output;
wherein the trainer administrator administrators is connected to the artificial intelligence processing unit through local area network and world wide web to setup the parameters related to the trial management and to monitor, view, compare and analyze data,
wherein the user is connected using any apparatus on the local area network and world wide web to attend assigned trial by the trainer administrator,
wherein the artificial intelligence processing unit comprises of an application server and a web server for the delivery of the animated content with audio visual effects, and
wherein the trainer administrator administrators set the trainer administrator programmed parameters for the user.

12. The system as claimed in claim 11, wherein the artificial intelligence processing unit is connected to the content storage unit which comprises of databases server for the storage of the data and media server for the storage of the audio-visual content.

13. The system as claimed in claim 11, wherein the trainer administrator is anyone connected to the system using local area network and World Wide Web.

14. The system as claimed in claim 11, wherein the system documents all the steps and history of the trial in the centralized database where the recorded data can be retrieved using local area network and World Wide Web.

15. The system as claimed in claim 11, wherein the delivery of the series of audio-visual content includes sequence, type, recurrence, length in terms total time, color, volume of the delivered audio-visual content and output type like print, tangible item, audio-visual content, audio-visual interactive content like game.

16. The system as claimed in claim 11, wherein the trainer administrators can view the recorded information sent to the artificial intelligence processing unit by the apparatus.
